(19) United States
(12) Patent Application Publication
(10) Pub. No.: US 2005/0280283 A1
(43) Pub. Date: Dec. 22, 2005

(54) Apparatus, method, and system for customizing and/or protecting a vehicle

(76) Inventor: Joseph S. Douglas, Jamaica, NY (US)

Correspondence Address: JOSEPH S. DOUGLAS, 147-28 ARLINGTON TERRACE, JAMAICA, NY, 11435, US

(21) Appl. No.: 10/870,234

(22) Filed: Jun. 16, 2004

(51) Int. Cl. B60J 1/00

(52) U.S. Cl. 296/136.1

(57) ABSTRACT

A method, system, and apparatus are provided for the protection and/or personalization of a vehicle. The apparatus includes a visible surface and at least one anchoring surface. The visible surface allows for the customization and personalization of tile vehicle. The visible surface additionally provides protection of the surface it covers from scratches, mars, dents and fading as well as acting as a theft deterrent system. The at least one anchoring surface affixes the visible surface to a particular surface of a vehicle.

### FIELD OF THE INVENTION

The present invention relates to the field of vehicle accessories, and in particular, to a method, system, and apparatus for protecting and/or personalizing a surface of a vehicle.

### SUMMARY OF THE INVENTION

The present invention is directed to a method, system, and apparatus for the protection of a surface and/or surfaces of a vehicle from scratches, mars, and/or dents. The present invention also allows an individual to personalize a vehicle. The present invention may also be used to deter the theft of a vehicle because of the individual characterization and/or ornamentation the present invention provides a vehicle. For example, a vehicle employing the present invention could be readily identifiable by authorities if stolen. The possible combinations of different materials, such as for example, fabric patterns, fabric colors, fabric cut, fabric lengths, and fabric textures coupled with the various make and model possibilities provides a great many combinations and permutations such that any number of vehicles employing the present invention would still be individual and distinct from each other.

The present invention can also be employed to allow the driver of the vehicle to be more conscious of speed restrictions, because an embodiment of the present invention can be restricted to certain maximum speed tolerance before it separates from the vehicle, thus causing the vehicle's driver to be more aware of the speed of the vehicle and thus adhere to speed restrictions. For example, an embodiment of the present invention can be configured such that if the driver of a vehicle employing the present invention exceeds seventy (70) miles an hour, the embodiment would separate from the vehicle. In the United States a number of state highways and interstates are restricted to speed limits of sixty-five (65) miles per hour. An embodiment of the present invention can be configured such that speeds beyond the maximum rating will cause the embodiment to breakdown, degrade, and/or otherwise become separated from the vehicle.

The present invention also provides a personal bond between the vehicle and its driver. The present invention can be custom cut to conform to the specific contours of the vehicle as well as be further personalized with, for example but not by way of limitations written characters, such as an expression, the driver's name, corporate slogan, country and/or city of origin, to match that of the language found on a vanity license plate, company name, trademark, trade name as well as cartoon characters and/or other expressive designs. The present invention can be used to announce and/or promote a business, product and/or service.

The present invention relates to accessories made for the protection of a vehicle surface and/or surfaces, and in particular to the protection of at least select regions of a vehicle's hood, fender and/or front end. Presently, there exist car bras and the like that serve similar functions. Bras are typically permanently affixed to the vehicle. Often times such attachment to the vehicle is through Velcro, which is visible to the eye and ascetically unsightly. The exposed Velcro also suggests to a passerby that the Bra can be readily removed and thus stolen.

The present invention has no unsightly attachments or adhesives that would come in direct contact with a vehicle's surface and possibly mar or leave any residue on the vehicle. A series of hooks, flaps and/or straps made of, for example and not by way of limitation, plastic, metal, nylon, and/or cables provide tension and anchor the present invention to the vehicle. Weights can also be added for stability and to insure that the present invention stays in communication with the surface contours on which it is placed. These hooks, flaps and/or straps can provide a measure of theft protection and/or prevention. For example, if the present invention is placed on tile hood of a vehicle then in order to remove it without damage, the hood of the vehicle would have to be unlatched. Hood locks are typically located inside the vehicle and can be protected by locking the doors of the vehicle when the vehicle is left unattended.

An apparatus is disclosed for personalizing at least one region on a vehicle. The apparatus includes a first layer. The first includes a first surface and a second surface, wherein the first surface includes a texturized material. The apparatus also includes a second layer. The second layer includes a first surface and a second surface, wherein the first surface of tile second layer is in communication with tile second surface of the first layer. The second layer includes at least one attachment point for releasably coupling the apparatus to a vehicle.

An apparatus is disclosed for customizing a vehicle. The apparatus includes a fur or fur-like material and an anchoring mechanism for affixing the fur or fur-like material to a vehicle. The anchoring mechanism contours and secures the fur or fur-like material to the shape of the at least one visible surface of a vehicle.

### BRIEF DESCRIPTION OF THE DRAWINGS

FIG. 1 is an exploded diagram of the component parts of an embodiment in accordance with the present invention.

FIG. 2 is a top view of an embodiment in accordance with the present invention.

FIG. 3 is a front view of an embodiment in accordance with the present invention affixed to the hood of a vehicle.

FIG. 4 is a three quarter view of an embodiment in accordance with the present invention affixed to the hood of a vehicle.

### DETAILED DESCRIPTION OF THE INVENTION

The present invention can be implemented in many different ways, and the following discussion will describe selected embodiments of the invention. These embodiments are intended as examples only, and not as an exhaustive list of all the forms the invention can take. In general, the present invention can be used with the widest possible variety of materials and/or fabrics and in connection with any visible surface of a vehicle.

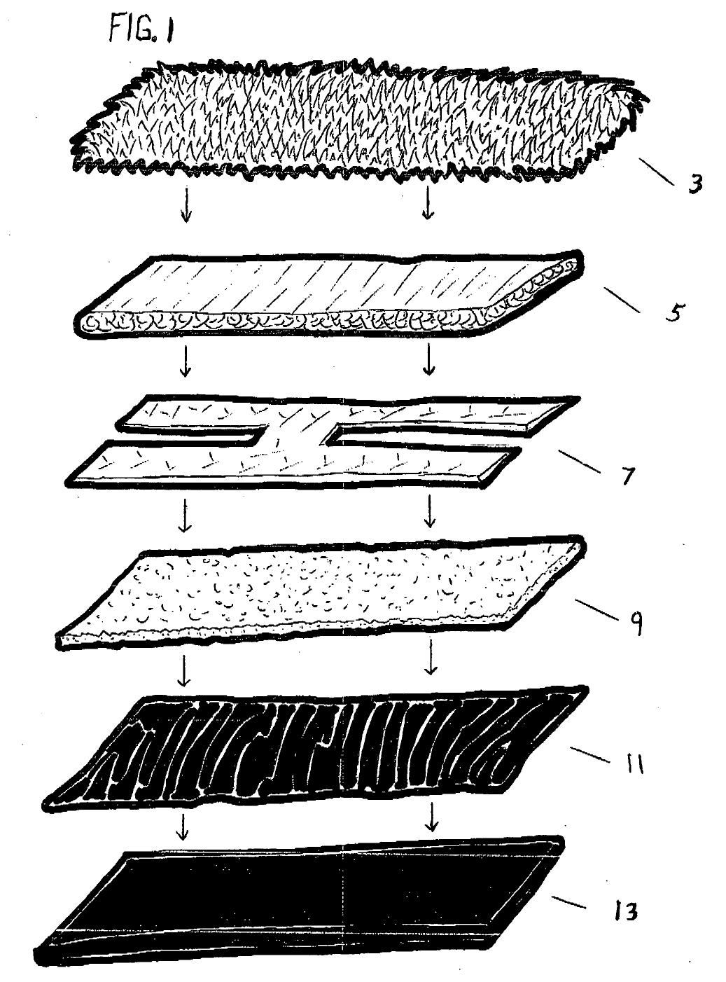

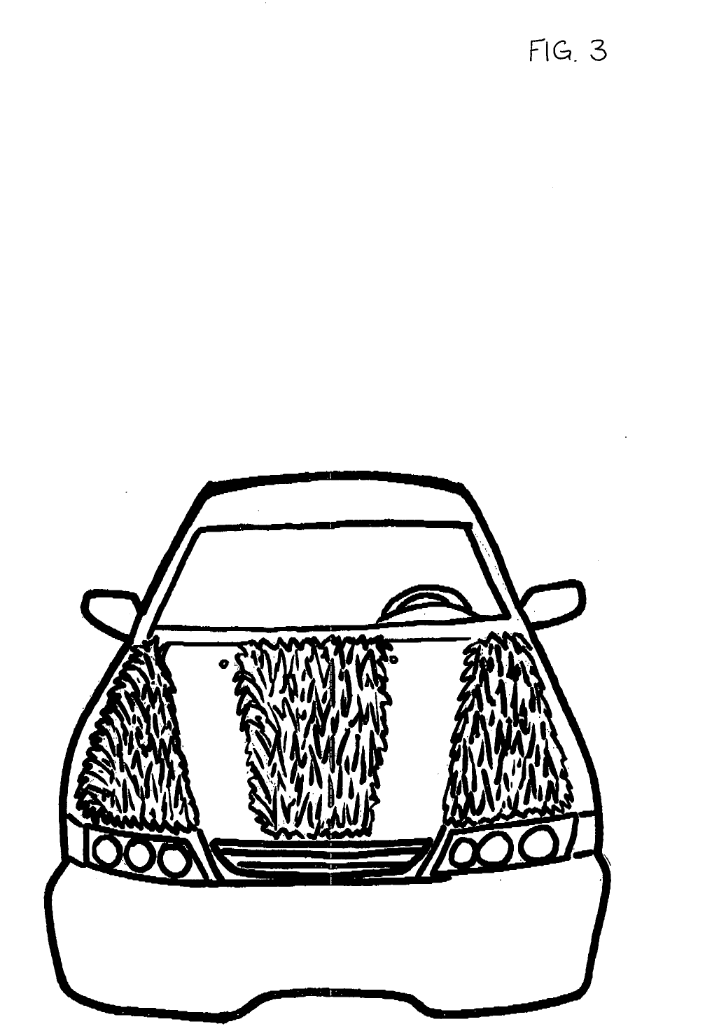

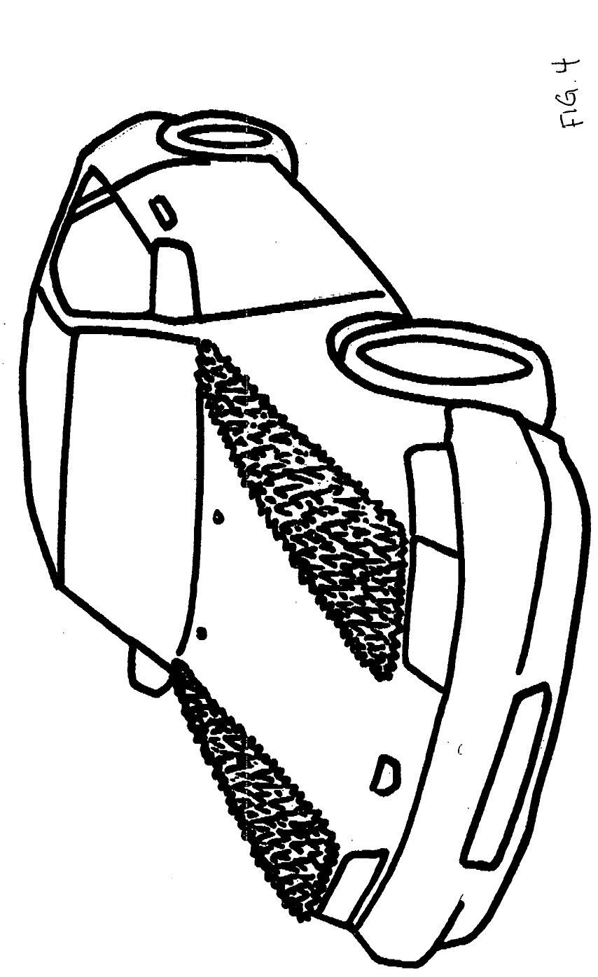

Referring now to FIG. 1, there is shown a top layer 3, which is fabric and/or other material. The top layer 3 can be, for example and not by limitations made of long or short fiber such as, for example, fur or any free flowing strand-like material. The dimensions of the embodiment shown in FIG. 1 are defined by the particular vehicle surface and/or area on which the present invention will be placed. The surface and/or area to be covered is called the “play area.” For example, the play area can be any area on a vehicle hood, from the top of the hood where the windshield wipers are located to the bottom of the hood where the headlights rest and as shown, for example, in FIGS. 3 and 4.

The top layer 3 can be treated to be water repellant and moisturized regularly to withstand the rays of the sun. In the embodiment shown in FIG. 1, the top layer 3 is affixed to the batting 5. The batting 5 acts to absorb shock and energy from airborne debris and is able to disperse excess moisture back into the atmosphere and keep the interior dry. The stabilization bar 7 or “H” bar 7 is made of, for example but not by way of limitation, Plexiglas, compressed wood, and/or thin gauge sheet metal. In the embodiment shown in FIG. 1, and in accordance with the present invention, the H bar 7 is centered and affixed to the batting 5. The H bar 7 adds rigidity and will drastically reduce the potential for flapping that can occur while driving. The H bar 7 acts as an internal skeleton to support the entire embodiment. The rigidity provided by the H bar 7 aids to maintain the embodiment contoured to the play area.

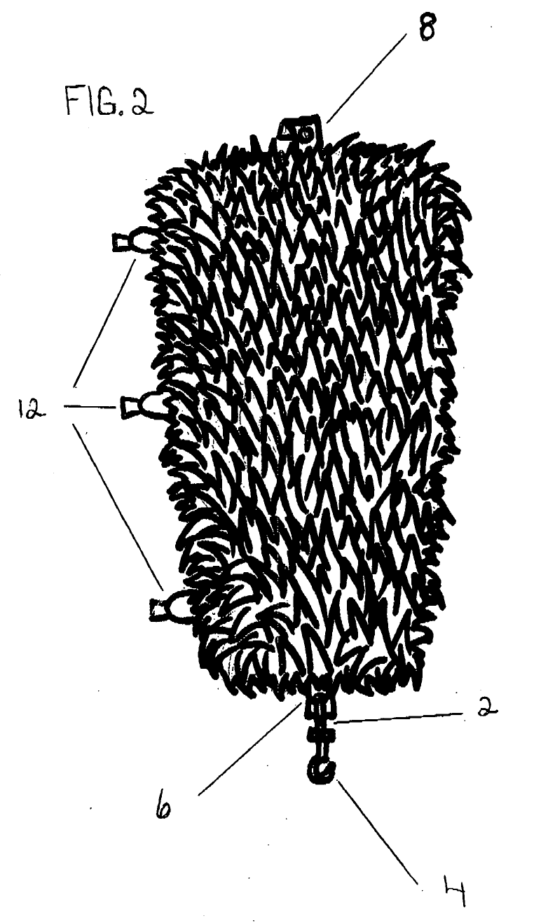

The cork 9 is adjacent to the other, non-batting 5, side of the H bar 7. The cork may have to be pre-flattened depending on how the cork is sold and the manufacturer. This can be accomplished through the use of weights or other heavy objects, such as for example, telephone books. The cork 9 acts to insulate and keep the heat from the engine separate from the heat above the hood. The cork 9 adds body and will not break down under humid conditions nor will it deteriorate in cold weather. The vinyl 11 or imitation leather 11 is laid on the cork 9 and the edges of layers 3, 5, 7, 9, and 11 are then affixed together. Magnetic sheeting 13 is affixed to 11. The magnetic sheeting 13 secures the embodiment shown in FIGS. 1 and 2 to the vehicle surface by providing an attraction and/or attachment to any ferrous surface. In some vehicles, such as for example, some Ford vehicles, more aluminum and magnesium is used in order to make the vehicle lighter. In such instances, and in accordance with the embodiment shown in FIG. 1, layer 13 can be omitted.

FIG. 2 illustrates an embodiment in accordance with the present invention showing connection points and coupling structures for affixing and/or anchoring an embodiment in accordance with the present invention to a vehicle surface. In FIG. 2 the embodiment is configured to attach to the hood of a vehicle. A tuck flap 12 provides horizontal stabilization for the embodiment shown in FIG. 2. If the play area is the hood of a vehicle, as in FIG. 2, the tuck flap 12 can be secured underneath the hood with Velcro. The tuck flap 12 should be of a size so as not to interfere with the opening or closing of the hood. The tuck flap 12 can be selected from, for example, a rubbery material that is similar to the material used to harness a racehorse. Such material exhibits slight elastic and nonabrasive characteristics. The tuck flaps 12 are collapsible and should be able to fold underneath the hood of a vehicle in between the open groove that separates the hood from the fender. In the embodiment shown in FIG. 2, the tuck flaps 12 are equidistant from one another. The present invention is not limited to tuck flaps 12 that are equidistant from each other. The number and the placement of tuck flaps 12 used are dependent upon the play area that will receive embodiments in accordance with the present invention.

The tuck flaps 12 shown in FIG. 2 can be affixed between the cork 9 and vinyl 11. The tuck flaps 12 and the metal strap 8 along with the plastic strap 6 create tension to hold the embodiment shown in FIG. 2 in place on the play area.

Alternatively, the metal strap 8 can be held in place with the aid of additional metal straps (not shown). These additional metal straps are laid perpendicular to metal strap 8, with one above and one below metal strap 8. In this configuration, metal strap 8 is sandwiched between the pair of metal straps (not shown).

The metal strap 8 shown in FIG. 2 contains perforated holes. Such metal strapping can be purchased pre-perforated, for example, pipe strapping can be used for metal strap 8. The perforated holes allow ease of alignment for “T” pin (not shown) and/or other affixing mechanisms to be inserted to make the metal strap 8 secured in place. The “T” pin is pushed in from the top layer 3 and straight through to the cork 9 and then bent backwards and flattened up against cork 9. Additional attachment mechanisms are also made possible and contemplated by the present invention.

In the embodiment shown in FIG. 2, the metal strap 8 and the plastic strap 6 are both pipe strapping that can be found in any plumbing store. The number of straps used is dependent upon the width and area of the play area. In the embodiment shown in FIG. 2, the plastic strap 6 is laid on the cork 9 with one strap underneath it and a second strap on top of it with the perforated holes aligned just as with the metal strap 8. The “T” pin (not shown) is inserted into the common hole to make the plastic strap 6 secured in place. The “T” pin (not shown) is punched in from top layer 3 and straight through to the cork 9 and then bent backwards and flattened up against cork 9. A wire cable 2 of a desired length in now thread through the first hole in the plastic strap 6 and pushed back inside the same hole until there is no more free cable 2. The opposite end of cable 2 is then twisted around the base of the hook 4 until there is no more space on the base of the hook 4. The cable 2 and the hook 4, for example and not by way of limitation, are the same as those used to haling pictures and are easily accessible at any hardware or Arts and Craft store. All of the hooks, flaps, straps, and/or other structures for affixing the embodiment shown in FIG. 2 to a vehicle surface, for example, the hood are folded or tucked underneath the hood of the vehicle so as not to compromise the ornamental value of the present invention.

It should therefore clearly be understood that the foregoing detailed description is intended by way of illustration, not limitation. It is only the following claims, including all equivalents that are intended to define the scope of this invention.

1. An apparatus for personalizing at least one region on a vehicle, said apparatus comprising:
a first layer, said first layer comprises a first surface and a second surface wherein said first surface comprises a texturized material
a second layer, said second layer comprises a first surface and second surface wherein said first surface of said second layer is in communication with said second surface of said first layer; and
wherein said second layer comprises at least one attachment point for releasably coupling the apparatus to said at least one region of said vehicle.

2. The apparatus according to claim 1, wherein said texturized material extends vertically out of the horizontal plain of said first surface.

3. The apparatus according to claim 1, wherein said texturized material is comprised of at least one of faux fur and animal fur.

4. The apparatus according to claim 1, wherein said first surface of said second layer is affixed to said second surface of said first layer by at least one of glue, T pins, Tidy pins, adhesive, and Velcro.

5. The apparatus according to claim 1, wherein second layer is releasably coupled to said at least one region of said vehicle by at least one of hanger strapping, magnetic sheeting, nylon straps, wire cable, hooks, and Velcro.

6. The apparatus according to claim 1, further comprising at least one rigid structure traversing said second layer.

7. The apparatus according to claim 1, wherein at least one region of said vehicle is the play area.

8. An apparatus for customizing a vehicle comprising
a fur or fur-like material;
an anchoring mechanism for affixing said material to at least one visible region of a vehicle, said anchoring mechanism contours and secures said material to the shape of the at least one visible region of said vehicle.

9. An apparatus comprising:
a fabric layer;
a second layer adjacent to said fabric layer, said second layer comprises a material that absorbs moisture;
a third layer adjacent to said second layer, said third layer comprises a material that provides rigidity to said fabric layer; and
a fourth layer adjacent to said third layer, said fourth layer comprises a material that grips the surface of a vehicle.
